(19) United States
(12) Patent Application Publication
(10) Pub. No.: US 2010/0028506 A1
(43) Pub. Date: Feb. 4, 2010

(54) PROCESS FOR PRODUCING HAM WITHOUT RESTING PERIODS FOR CURING

(75) Inventors: Cesar Dalmacio Mora Castillo, Tultepec (MX); Carlos Lopez Urueta, Monterrey (MX); Hector Hernandez Jimenez, Guadalupe (MX); Gregorio De Haene Rosique, San Pedro Garza Garcia (MX)

Correspondence Address: MICHAEL WINFIELD GOLTRY, 4000 N. CENTRAL AVENUE, SUITE 1220, PHOENIX, AZ, 85012, US

(73) Assignee: SIGMA ALIMENTOS, S.A.DE C. V., SAN PEDRO GARZA GARCIA (NL)

(21) Appl. No.: 12/526,736

(22) PCT Filed: Feb. 12, 2008
(86) PCT No.: PCT/MX08/00019

§ 371 Date: Aug. 11, 2009

(30) Foreign Application Priority Data
Feb. 12, 2007 (MX) MX/A/2007/001738

(51) Int. Cl. A23L 1/318

(52) U.S. Cl. 426/281

(57) ABSTRACT

A process for producing ham without resting periods for curing, comprising the following steps in which: the pieces of muscle are cleaned, a brine composition is injected into the muscles pieces, a series of controlled-depth incisions is made on the muscle pieces that have been injected with the brine composition, the injected muscle pieces are massaged, and the massaged muscle pieces are stuffed into the casing. The muscle pieces are massaged using a random movement involving the circulation and recirculation of the pieces so as to accelerate the diffusion of the brine composition and to perform curing reactions, thereby producing an essentially uniform muscle consistency free of bruises, tears and/or spots.

### TECHNICAL FIELD OF THE INVENTION

The present invention relates to a process for producing meat and food products, more specifically to a process for producing ham without resting periods for curing.

### BACKGROUND OF THE INVENTION

At present the process for producing hams imply long resting stages to allow the curing of the ham. In this description, the term “resting period for curing” refers to the stage of a process that usually takes place before, during or after the stage of massage, for leaving the pieces of muscle to rest, previously treated with a brine solution, in general conditions of refrigeration, for a period ranging from several hours to several days so that the brine is dispersed in the muscle and performs the curing reaction of the product.

Examples of the current processes for producing ham are described in the documents listed below.

Miguel Marin Labat, in the Spanish patent ES-8304408, describes a procedure for preservation and curing pork hams. In said process, the fresh ham is deboned without tearing the aponeurosis of the muscle, and next a minimum quantity of salted mixture is added in order to achieve the curing; then the grid is bottled and placed in the appropriate conforming container which is located in a cooling chamber between 15 and 30 days until the salting mixture completely impregnates the piece of meat. Finally, the piece is placed in a chamber submitted to a temperature between 20° C. and 40° C., and with a relative humidity between 55% and 78% during a period between 40 days and 60 days.

Neil B. Webb, in the U.S. Pat. No. 4,753,809, describes a process for curing hams, where first, the portions of meat are mixed with a mixture of curing, to be stored for a period of 3 days to 10 days (resting period for curing), then the portions of meat are smoked and submitted to ultraviolet light for a period of 8 days to 20 days, at the end of this period, the excess fat is removed, and the ham is formed to be cooked.

Antonio Porta Barraca, in the Mexican patent MX-167,162, describes a procedure for preparing and curing a meat product, in which the pieces of meat are seasoned with a salting mixture, then the pieces are introduced, after adaptation of said pieces to acquire a final shape, in a cooling chamber for equalizing the salting mixture (resting period for curing) at a temperature between −1° C. to 5° C., and a maximum vacuum pressure over a period of time between 48 hours to 72 hours, at which the salting mixture penetrates into the muscle mass, with the peculiarity that a device performs the massage phase, rotating continuously at a maximum of 10 rpm.

Seamus Carroll, in the British patent publication GB-2,288,308, describes a process for producing ham, in which the pieces of muscle are selected and taken to a curing station where they are injected with a brine solution. The injected muscle pieces first receive a massage, and then are stored (resting period for curing) at a temperature between 3° C. to 6° C. for a period of 24 to 48 hours. Once the resting period for curing has been accomplished, the pieces receive a second massage, the waste material is removed from they and are then formed and cooked as pieces of cooked ham.

Evin Dilber-Van Griethuysen and others, in the publication of European patent EP-0683986, describe a process for manufacturing cooked ham, said process involves cleaning and cutting pig muscles into pieces, which are treated at a hydrostatic pressure within a margin of 300 bar to 2000 bar, then the pieces are injected with brine to be massaged, cooked and cooled down later on. This process, during the massage stage, involves alternating resting periods for curing that range from 2 to 24 hours.

Terence Whelan, in the British patent publication GB-2,369,284, describes a process for producing a product of dry cured ham, in which a brine composition is applied to boneless, adapted and softened cuts of meat, to be passed to a stage of curing and storage (resting period for curing) at a temperature of 2° C. to 5° C. for a period of 3 to 5 days. Once the resting period for curing is accomplished, the cuts of meat are submitted to two stages of cooking, the first stage of cooking is performed at a temperature of 60° C. to 70° C. for 5 to 10 hours, whereas the second stage of cooking involves partial cooking of the cuts of meat at a temperature of 70° C. to 80° C. for 2 to 4 hours in order to produce a high-quality dry cured ham.

The state of the art described above, to produce similar products or hams, involves processes for produce meat food products that require large resting periods for curing. This implies limitations to a food industry where reducing delivery times and its cost are important, therefore, it is necessary to provide a process for producing food of the type of ham, or similar without resting periods for curing during the process.

### SUMMARY OF THE INVENTION

In view of the above, and with the objet of finding solutions to the limitations encountered, it is objet of the invention to provide a process for producing ham without resting periods for curing, said process comprises the steps of cleaning pieces of muscle; injecting the interior of the pieces of muscle with a brine composition; making a series of controlled-depth incisions in the pieces of muscle injected with the brine composition; applying massage to the pieces of muscle injected with the brine composition; stuffing the pieces of massaged muscle; and cooking the pieces of stuffed muscle to obtain ham; wherein the step of applying massage is done through a random movement involving the circulation and recirculation of the pieces of muscle so as to accelerate the diffusion of the brine composition and to perform curing reactions, thereby producing an essentially uniform muscle consistency free of bruises, tears and/or spots.

### BRIEF DESCRIPTION OF THE FIGURES

The characteristic details of this invention are described in the following paragraphs in conjunction with the accompanying figures, which are intended to define the invention, but without limiting its scope.

FIG. 1 is a block diagram that describes a process for producing ham according to this invention.

FIG. 2 is a perspective and section view of a apparatus for the massage of meat pieces, used in the process for producing ham according to this invention.

### DETAILED DESCRIPTION OF THE INVENTION

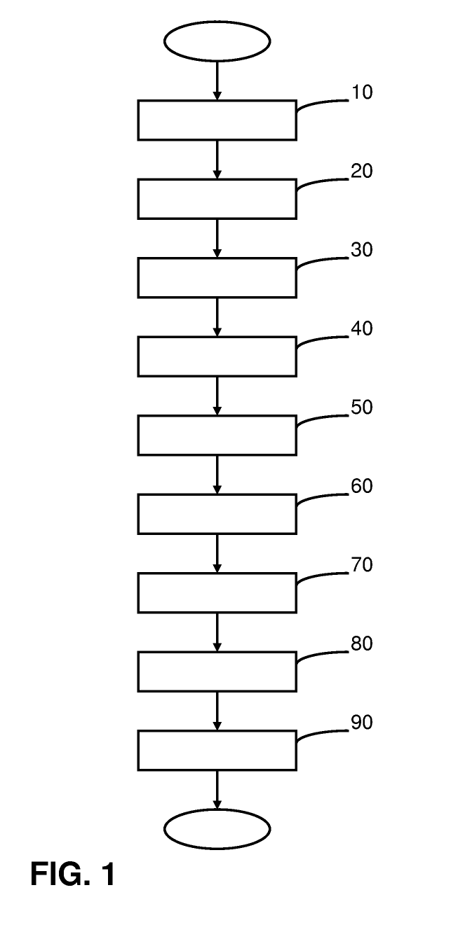

Referring to FIG. 1, a process for producing ham is illustrated, the process starts in step 10 where the raw materials, fresh or frozen meat, hereafter referred to as pieces of muscle, are inspected sensorially to ensure that these materials are suitable for use and determine whether they require a period of defrost or not.

In cases where the raw materials are frozen pieces of muscle, in step 20, a stage of defrosting is performing, in which the pieces of frozen muscle are mixed with salt in a weight ratio of about 1% of the weight of the pieces of muscle, and moreover, ensures that there is no loss of fluid. The addition of salt during the defrosting, contributes to the elimination of resting periods for curing of the pieces of muscle during the process, thus contributing to a faster curing of the product with the help of the other stages described below.

In case the raw material includes pieces of fresh muscle, these can pass to the next stage of the process of this invention, or including they can be mixed previously with salt in a similar proportion to the proportion of salt to the pieces of frozen muscle.

Once the pieces of muscle are defrosted and/or salted, in step 30, are passed to the deboning and cleaning operation in order to obtain pieces of muscle free of fat, ligaments and cartilages, as well as semi-lean cuts or cuttings, and cuts that by color and/or flavor are intended for the grinding process.

Both, during the defrosting operation and during the deboning operation, the efficiency of the operation is determined. In the case of the deboning operation, the amount of superficial fat is controlled, while the defrosting operation is performed determining the amount of fluid lost during the operation.

Once defrosted, salted or not, and the pieces of muscles cleaned, in step 40, a brine composition is injected into the interior of the pieces of muscle, this stage of injection is performed, for example, in a dual head injector, so that the prepared brine compound falls by gravity into a tank that has a filtering system, so as to remove particles that could clog the needle punctures. The brine compound is injected under pressure into the pieces of muscle that travel by a conveyor so that the brine is spread in the muscle.

During the injection stage of the brine compound, the brine compound is injected in an amount comprised of about 30% to about 110% in weight in relation to the weight of the pieces of muscle, but in a manner preferably of about 30% to about 50% in weight in relation to the weight of the pieces of muscle, for which a weighing operation is to be performed to determine this percentage.

At the exit of the injector, a conveyor carries the injected pieces of muscle into softening operation that takes place in step 50. Here, the injected pieces of muscle receive the cutting action by some blades mounted on some cylinders. The step between these cylinders is regulated to perform a series of superficial incisions and around the pieces of muscle with a depth ranging from about 12 mm to about 15 mm. This depth of cut contributes to the elimination of the resting periods for curing in the process, and at the same time provides a major smoothness, and a major sharing of compounds during the massage stage that is described below.

Once the softening stage is performed, tests are performed to establish the level of injection of the brine compound reached, so that when there is an excess or a lack of the brine solution to reach the required percentage of injection, then (in step 60) the pieces of muscle are mixed with the series of cuts with ground meat (usually obtained from semi-lean cuts or cuts that were collected and ground in step 30) and with the brine compound.

Once regulated the percentage of the brine compound in the pieces of muscle, the next stage in the process is performed in step 70, which consists of a continuous massage and under conditions of vacuum. The aim of this operation is continuing to accelerate the diffusion of the brine compound in the pieces of muscle, due to a combination of a knocking from muscle to muscle (involving movement) and muscle to wall of the equipment (dispersing movement).

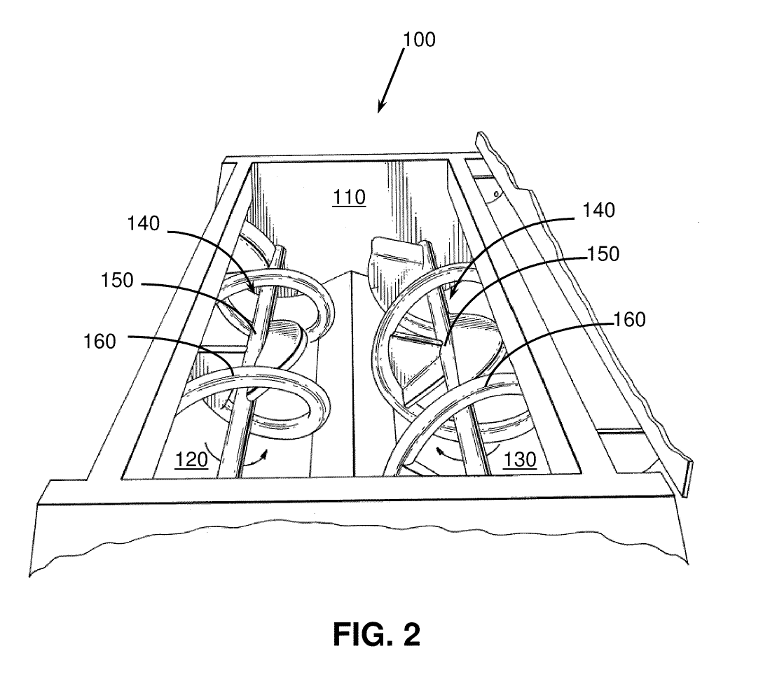

This massage is done through a random movement of circulation and recirculation of said pieces of muscle, to exudate most protein possible in the shortest time possible, yet at the same time causing an essentially uniform muscle consistency free of bruises, tears and/or spots. An example of an apparatus used for this purpose is described by A. Valerio Baccetti in the U.S. Pat. No. 4,441,231, and that this description is made with reference to FIG. 2, which shows a perspective and sectional view of the apparatus for the massage of meat pieces 100 which has a container 110 with at least two contiguous curved sections 120 and 130, and an agitator 140 rotating on its horizontal axis in each of the curved sections 120 and 130 of container 110, so that the agitator 140 has a shank 150 and a coaxial helix 160 to the shank 150. The coaxial helix 160 has a generally circular cross section. Both agitators 140 curves in contiguous curved sections 120 and 130 can preferably rotate in opposite and alternate directions, in order to cause a random movement of circulation and recirculation of the pieces of muscle according to the evolving and dispersing movements required in the process of this invention.

The massage stage of the pieces of muscle, with or without ground meat (which were added or not in step 60) is carried out in the apparatus described above, under vacuum and continuously without resting periods, whether alternating or not the direction of rotation of the agitators 140. This type of massage allows that in the pieces of muscle, without any resting period for curing, the curing reactions are carried out and the solubilization and extraction of proteins are continued by facilitating the diffusion process of fluids, and simultaneously carrying out an homogenization of the pieces of muscle with the ground meat, thus producing, in the final stage of the massage, a food paste of ham of an essentially uniform muscle consistency free of bruises, tears and/or spots.

In order to give the pieces of muscle a proper massage and to eliminate the resting periods for curing of the process, in the stage of massage, the apparatus should preferably operate at a temperature of about 2° C. to about 10° C., while the agitators 140 are spinning at a frequency of rotation in the interval of about 20 rpm to about 40 rpm during a period of about 90 minutes to about 120 min, the above according to the amount and weight of the pieces of muscle, as well as the brine concentration in said pieces.

Optionally, during the stage of massage, more brine may be added in order to accelerate the curing, or other ingredients to add some peculiarity to the final product.

The next stage in the process is performed in step 80, and consists of stuffing the paste of ham obtained from the phase of massage in the package that will turn it into its final presentation. The packaging gives the ham a primary form, protects the product against physical damage, maintains product quality and prevents it from contamination. Said stage of stuffing is conducted according to the current technique, where usually the product is transferred to a vacuum filler to remove possible air from the product, and limit the amount of said product in the package, and as such transferring the food paste of ham to the stuffing equipment. It should be mentioned that the stuffing stage may be immediately followed by a molding-under-pressure stage, in order to give the final product a particular form.

Finally, and according to the current state-of-the-art technology, the stuffed and/or molded products are transferred to the cooking operation, which takes place in step 90, so that during the cooking, the salt-soluble proteins from the meat start a series of transformations at macromolecular level, in which reactions are carried out, changes in the water retention capacity, increase in the solubility of substances, changes by association, disintegration and denaturation of the protein fractions, leading to the formation of the network in three dimensions that give coherence to the piece of ham, as well as the formation of the pale pink color pigment, characteristic of cured meats.

### Example of Embodiment of the Invention

The invention will now be described with respect to the following example, which is solely for the purpose of representing the embodiment of the principles of the invention. The following example shows the comparison of a control sample and a sample according to the invention, which is not intended to be an exhaustive representation of the invention, nor intends to limit the scope of this invention.

### Preparation of the Control Sample

A portion of virginia-type ham of 4,000 kg of turkey meat is produced according to the procedure of the current state-of-the-art.

After cleaning, the turkey meat is injected with a brine preparation in an amount of about 86% in weight of said turkey meat, where the brine preparation was prepared for 45 minutes. The injection of the brine composition along with the softening of the pieces of turkey meat was carried out during a period of 50 minutes.

The pieces of turkey meat are then submitted to a massage in a rotating drum for 22 rpm for approximately 2 hours 20 minutes of massage at a temperature of 6° C. Later, the massaged meat pieces are submitted to a resting period for curing of about 12 hrs before being stuffed.

The stuffed pieces were cooked in a cooking pan at a water temperature of approximately 80° C., until reaching an internal temperature of the ham product of 75° C. The total cooking time was approximately 3 hours 30 minutes.

Finally, the cooked pieces of ham are cooled in a cooling pan at a water temperature of about 2.6° C., until reaching an internal temperature of the ham product of 5° C. The total cooling time was approximately 4 hours 30 minutes.

### Preparation of the Sample According to the Invention

A portion of virginia-type ham of 4,000 kg of turkey meat is produced according to the procedure of the method of this invention.

After cleaning, the turkey meat is injected with a brine preparation in an amount of about 105% in weight of said turkey meat, the brine preparation was prepared for 45 minutes. The injection of the brine composition along with the softening of the pieces of turkey meat was carried out during a period of 50 minutes.

Next, the pieces of turkey meat are submitted to a random massage of a circulation and recirculation movement of said pieces of meat in an apparatus of the Cozzini brand (as described in FIG. 2) at a temperature of about 3° C., where the agitators are spinning at first at a rotation frequency of about 25 rpm in 7 alternating cycles of evolving and dispersing rotation, then they are turned for 30 rpm in a cycle of dispersing motion, to be turned next for 35 rpm in a cycle of evolving motion, and finally turned for 40 rpm in a cycle of dispersing motion. All these cycles of massage over a period of about 2 hours 30 minutes.

Later, the massaged pieces of meat and without resting period for curing are subjected to a stuffing process. The stuffed pieces were cooked in a cooking pan at a water temperature of about 80° C., until reaching an internal temperature of the ham product of 75° C. The total cooking time was approximately 3 hours 30 minutes.

Finally, the cooked pieces of ham are cooled in a cooling pan at a water temperature of about 3.3° C., until reaching an internal temperature of the ham product of 8° C. The total cooling time was approximately 3 hours.

The comparative parameters of the obtained ham product according to the process of the invention and the control sample are presented in Tables I, II, III, IV and V which are shown below.

TABLE I
Results of sensory analysis
(First analysis after 24 hours of the processing of the ham)

| | | Sample according to the |
|---|---|---|
| Parameter | Control Sample | invention |
| Free water (0.3% | 0.064 | 0.064 |
| Standard) | | |
| Hardness | 13087.956 | 13457.12 |
| Elasticity | 0.910 | 0.918 |
| Cohesion | 0.372 | 0.417 |

TABLE II
Results of sensory analysis
(First analysis after 9 days of the processing of the ham)

| | | Sample according to the |
|---|---|---|
| Parameter | Control Sample | invention |
| Free water (0.3% | 0.110 | 0.089 |
| Standard) | | |
| Hardness | 13093.992 | 12936.4 |
| Elasticity | 0.800 | 0.838 |
| Cohesion | 0.283 | 0.274 |

TABLE III
Results of sensory analysis
(First analysis after 14 days of the processing of the ham)

| | | Sample according to the |
|---|---|---|
| Parameter | Control Sample | invention |
| Free water (0.3% | 0.107 | 0.064 |
| Standard) | | |
| Hardness | 13244.27 | 13823.69 |
| Elasticity | 0.902 | 0.914 |
| Cohesion | 0.392 | 0.369 |

TABLE IV
Results of sensory analysis
(First analysis after 23 days of the processing of the ham)

| | | Sample according to the |
|---|---|---|
| Parameter | Control Sample | invention |
| Free water (0.3% | 0.071 | 0.066 |
| Standard) | | |
| Hardness | 11942.79 | 11933.66 |
| Elasticity | 0.969 | 0.918 |
| Cohesion | 0.380 | 0.430 |

TABLE V
Results of sensory analysis
(First analysis after 34 days of the processing of the ham)

| | | Sample according to the |
|---|---|---|
| Parameter | Control Sample | invention |
| Free water (0.3% | 0.224 | 0.092 |
| Standard) | | |
| Hardness | 14789.98 | 14026.86 |
| Elasticity | 0.864 | 0.920 |
| Cohesion | 0.378 | 0.420 |

Based on the achievements described above, the modifications of the implementation environments described, as well as the realization of alternative environments will be considered obvious to a person skilled in the art of the technique under this description. It is therefore provided that the claims cover such modifications and alternatives that are within the scope of the present invention or its equivalents.

1. A process for producing ham without resting periods for curing, said process comprising the steps of:
cleaning pieces of muscle;
injecting a brine composition into the interior of said pieces of muscle;
making a series of controlled-depth incisions in said pieces of muscle injected with the brine composition;
applying massage to said pieces of muscle injected with the brine composition;
stuffing said massaged pieces of muscle; and
cooking said stuffed pieces of muscle to obtain ham;
wherein said process for producing ham is characterized by said massage is performed through a random movement involving the circulation and recirculation of the pieces of muscle so as to accelerate the diffusion of the brine composition and to perform curing reactions.

2. The process of claim 1, wherein said step of cleaning the pieces of muscle including the steps of:
defrosting said pieces of muscle that are frozen;
adding salt in an amount of about 1% in relation to the weight of said pieces of muscle; and
deboning and cleaning fat, ligaments and cartilage from said salted pieces of muscle.

3. The process of claim 1, wherein the step of injecting a brine composition into the interior of said pieces of muscle, in which said brine composition is injected in an amount of about 30% to about 110% in weight in relation to the weight of said pieces of muscle.

4. The process of claim 3, wherein said brine composition is injected at an amount comprised of about 30% to about 50% in weight in relation to the weight of said pieces of muscle.

5. The process of claim 1, wherein the step of making a series of controlled-depth incisions in said pieces of muscle injected with the brine composition, said incisions have a depth of about 12 mm to about 15 mm.

6. The process of claim 1, wherein further including the step of mixing said pieces of muscle injected with the brine composition with ground meat.

7. The process of claim 1, wherein said step of applying massage to said pieces of muscle injected with the brine composition, is performed through an apparatus for the massage of pieces of meat, which including:
a container with at least a curved section; and
an agitator rotating on its horizontal axis in each of the curved sections of the container, wherein said agitator including a shaft and a coaxial helix to said shaft, so that said helix is the generally circular cross section, wherein the agitators in contiguous curved sections preferably rotate in the opposite direction, causing a random movement of circulation and recirculation of the pieces of muscle as a whole.

8. The process of claim 7, wherein said agitators rotate in a range comprised between about 20 rpm to about 40 rpm.

9. The process of claim 1, wherein said massage is performed at a temperature of about 2° C. to about 10° C.

10. The process of claim 1, wherein said massage is performed during a period of about 90 minutes to about 100 minutes.

11. The process of claim 1, wherein said step of applying massage to said pieces of muscle injected with the brine composition, including the step of adding more brine composition in order to accelerate the curing, or other ingredients that add certain peculiarity to the ham product.
